(19) United States
(12) Patent Application Publication
(10) Pub. No.: US 2016/0063635 A1
(43) Pub. Date: Mar. 3, 2016

(54) System, Method, and Apparatus for Flood Risk Analysis

(71) Applicants: Emmett Collazo, Jupiter, FL (US); Thomas Little, Mullical Hill, NJ (US); Winfield Scott Anderson, JR., Palm Beach Gardens, FL (US)

(72) Inventors: Emmett Collazo, Jupiter, FL (US); Thomas Little, Mullical Hill, NJ (US); Winfield Scott Anderson, JR., Palm Beach Gardens, FL (US)

(21) Appl. No.: 14/215,966

(22) Filed: Mar. 17, 2014

(51) Int. Cl. G06Q 40/08; H04N 5/225; G06K 9/00; G06T 7/00; G06Q 50/08; G06F 17/30

(52) U.S. Cl. CPC G06Q 40/08; G06Q 50/08; G06F 17/30241; G06K 9/00677; G06T 7/004; H04N 5/225; G06T 2210/61

(57) ABSTRACT

A method, system, apparatus and computer readable storage medium is provided for taking information related to a specific real property structure, including customer information; information regarding uses of real property (residential, industrial, commercial, living spaces, crawl spaces, etc.); elevation, slope, and grade information; base flood elevation data; flood depth; use of flood mitigation devices (e.g., breakaway walls, flood vents); survey information; the use of design professionals in mitigation of risk; and other matters; and using this information to identify means of reducing risk, including use of, or repositioning of, flood mitigation devices; reinforcement of structures, use of design professionals, and other matters, in order to assess and mitigate risk.

The invention also relates to means for quantifying and reducing excess risk coverage premiums for homes not covered by National Flood Insurance Program flood plain insurance, or for excess insurance coverage over minimum required insurance amounts.

This application claims the benefit of U.S. Provisional Application No. 61/791 352 , filed Mar. 15, 2013, the disclosures of which are incorporated herein by reference.

### BACKGROUND OF THE INVENTION

In the United States, a large number of American homes are at risk for floods, and may be covered by flood insurance. Many private insurers do not insure against the peril of flood due to the prevalence of moral hazard and adverse selection phenomena, for example, in the purchase of insurance by persons most affected by the specific peril of flood. In such cases, traditional insurance is not available. Whereas for other insurable risks, insurers use the economic law of large numbers to charge a relatively small fee to large numbers of people in order to pay the claims of the small numbers of claimants who have suffered a loss. In flood insurance, typically the numbers of claimants is larger than the available number of persons interested in protecting their property from the peril, which means that most private insurers view the probability of generating a profit from providing flood insurance as being remote. Additionally, while there are insurers that do provide privately written primary flood insurance for high value homes, the underwriting and provision of such insurance does not account for many flood risks.

In certain flood-prone areas, the federal government requires flood insurance to secure mortgage loans backed by federal agencies.

The lack of flood insurance can be detrimental to many homeowners who may discover only after the damage has been done that their standard insurance policies do not cover flooding. Flooding can occur due to various natural disasters, for example earthquakes, landslides, tsunamis, or other natural disasters. Few insurers in the U.S. provide flood insurance coverage due to the hazard of flood typically being confined to a few areas. As a result, it is an unacceptable risk due to the inability to spread the risk to a wide enough population in order to absorb the potential catastrophic nature of the hazard.

### SUMMARY OF THE INVENTION

It is an object of the invention to provide to consumers, real property owners, construction entities, insurance companies, government agencies, and other entities concerned with flood risks, a system, apparatus, and method for analyzing information related to a specific real property structure, including customer information; information regarding uses of real property (residential, industrial, commercial, living spaces, crawl spaces, etc.); elevation, slope, and grade information; base flood elevation; flood depth; use of flood mitigation devices (e.g., existence of breakaway walls or flood vents); survey information; the use of design professionals in mitigation of risk; and other matters; and using this information to identify means of assessing and reducing risk, including use of, or repositioning of, flood mitigation devices; reinforcement of structures, use of design professionals, and other matters, in order to mitigate risk. It is an additional object of this invention to analyze means of reducing risk whether or not all identified input variables are known.

It is an additional object of the invention to quantify and reduce excess risk coverage premiums for homes not covered by National Flood Insurance Program flood plain insurance, including but not limited to high value homes.

It is an additional object of the invention to error-check elevation certificates, insurance companies' calculations of premiums, surveyors, and regional and community flood plain managers.

It is an additional object of the invention to error-check structures for the need to have flood insurance, and whether options exist to remove regulatory burdens.

### DRAWINGS

FIG. 1 is an embodiment of an interface for obtaining information concerning a real property.

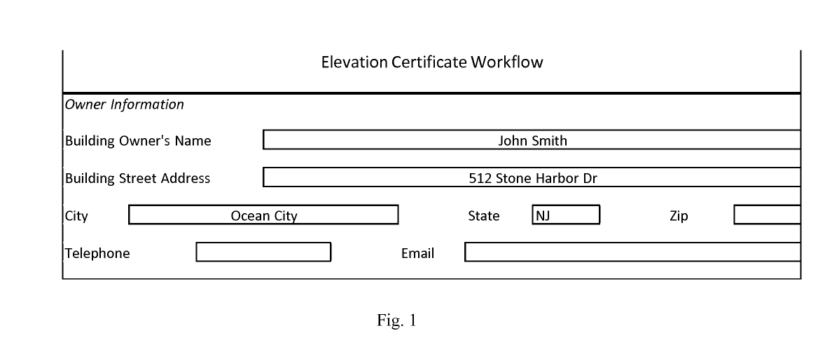

FIG. 2 is an embodiment of an interface for obtaining characteristics of a real property.

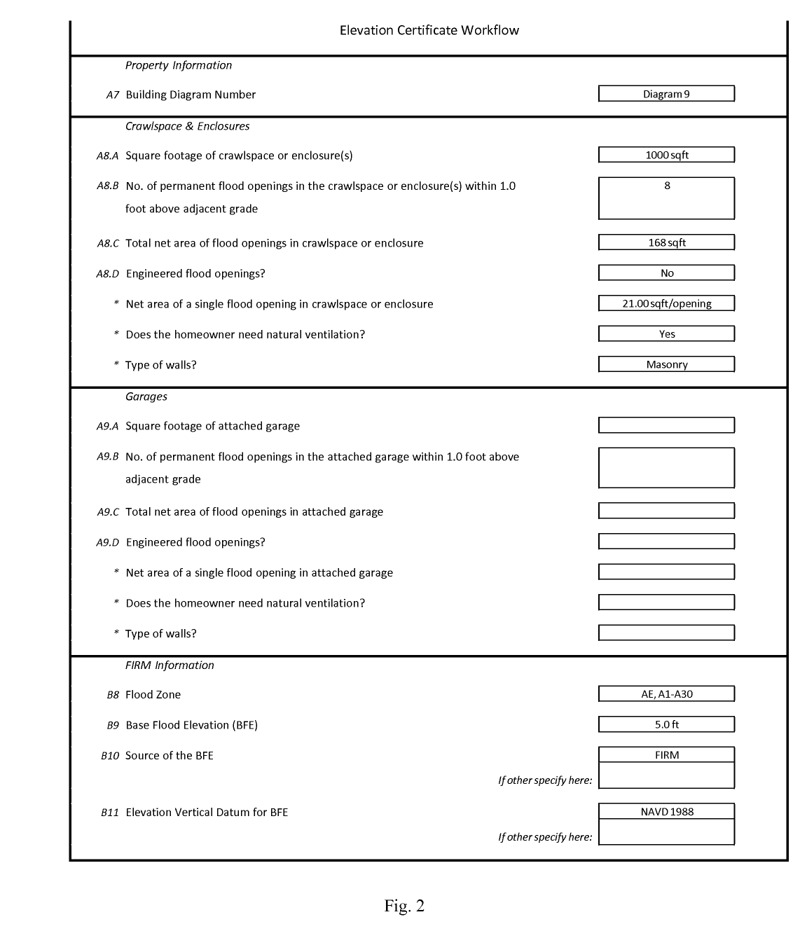

FIG. 3 is an embodiment of an interface for providing flood risk guidance, factors which would increase or reduce insurance costs, recommendations for movement of heating or air conditioning structures, regulatory requirements for receipt of flood insurance, and related guidance and information.

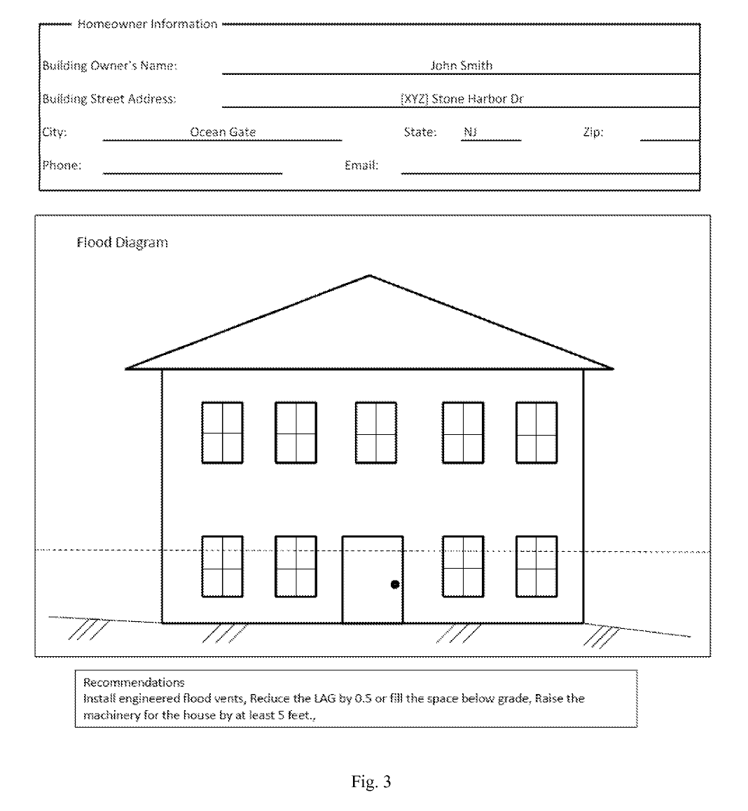

### DETAILED DESCRIPTION

In one embodiment of the invention, the following Sections A, B, C, and D, identify information to be included in the “input” section. Data can be entered and as it is entered flags and reference guidance will identify requirements for prompting the surveyor or professional for accurate information. The embodiment of a software product, service, or application will allow the input of this information for flood risk assessments. In one embodiment of the invention, an application will also automatically fill out an elevation certificate.

In one embodiment of the innovation, unlike other software or applications that collect data to offer a risk analysis, this one will generate a graphical output that an untrained professional understands. Optionally, an embodiment of the software product, service, or application will also search for possible discrepancies on the elevation certificate, and offer a means, a “red flag,” or a grade or rank of the accuracy of that document.

For example, during the data entry steps, data may be related to the height of the mechanicals. A user could enter data showing that the boilers, water heaters, HVAC, condensers, outside unit compressors, or additional units or modules used for home support, are below the base flood elevation, and a prompt may recommend taking digital pictures of that area, and attach the photographs to the comment section.

As an additional option for an embodiment of the invention, a perpetual rating for a surveyor's accuracy will be generated offering another tool for insurance companies to use to gauge risk. This will dramatically reduce the number of incorrectly filed elevation certificates by untrained surveyors that are not identified through a insurance risk evaluation system.

An embodiment of the invention may optionally also automatically fill out an elevation certificate and prompt with help to insure the lowest risk.

An embodiment of the invention may optionally include the some or all of the following information as input variables.

### Section A Property Information

A1. Building Owner's Name
A2. Building street address
A3. Property Description Lot/Block/tax parcel/Legal Description
A4. Building use (e.g., Residential, Non-residential, addition, accessory)
A5. Latitude and Longitude
A6. Photographs
A7. Building Diagram Number
A8.a Square Footage of crawlspace or enclosure
A8.b Number of Floodvents within 1′ of adjacent grade
A8.c Total coverage of all Floodvents
A8.d Whether flood vents are engineered in accordance with an ICC-ES evaluation report, or design professional engineered opening certificate. Optionally, the interface may request that a user identify whether a design professional visited the structure and physically reviewed an actual property, or reviewed documents sufficient to establish characteristics of the property, gradient, structure, and similar information.

For buildings with attached garage:
A9.a Square Footage of crawlspace or enclosure
A9.b Number of Floodvents within 1′ of adjacent grade
A9.c Total coverage of all Floodvents
A9.d Whether flood vents are engineered in accordance with an ICC-ES evaluation report, or design professional engineered opening certificate.

Additional information:
A10
   a. Whether Floodvents exist on at least 2 different walls per enclosed area in any crawlspace; in any full height, walk-out enclosure; or in any other enclosed area below the base flood elevation.
   b. Whether Floodvents exist on at least 2 different walls per enclosed area in any garage
   c. Digital Pictures of all Floodvents
   d. Whether breakaway walls have a certification for any crawlspace
   e. Whether breakaway walls have a certification for any garage
   f. Whether any enclosed area lies below the BFE, and if so, whether that enclosed area is used for anything other then storage and parking
   g. Measurements from the bottom of all flood vents to the adjacent grade

### Section B Flood Insurance Rate Map Information

B1. NFIP Community Name and Community Number
B2. County Name
B3. State
B4. Map/Panel number
B5. Suffix
B6. Firm Index Date
B7. FIRM Panel Effective Revised Date
B8. Flood Zones
B9. Base Flood Elevation (BFE) Zone AO use base flood depth
B10. Indicate the source of the BFE
B11. Indicate the elevation Datum used for the BFE
B12. Is the Building located in a coastal Barrier Resource System-Designation Date

### Section C Building Elevation Information (Survey Required)

C1. Building evaluations are based on:
Construction Drawings □ Building Under Construction □ Finished Construction □
C2. Elevation-Benchmark Utilized □ Vertical Datum □
C2a. Top of the Bottom Floor (including basement, Crawlspace, or enclosed floor)
C2b. Top Of the next higher floor
C2c.Bottom of the lowest horizontal structural member (v zones only)
C2d. Attached garage top of slab
C2e. Lowest elevation of Machinery or Equipment
C2f.Lowest Adjacent Grade (LAG) next to building
C2g. Highest Adjacent Grade (HAG) next to building
C2h. Lowest Adjacent Grade at lowest elevation of deck or stairs

### Section D Surveyor, Engineer or Architect Certification

Certifiers Name/Title/Address/License Number/Signature/Phone
   a. Is the certifier a Certified Floodplain Manager?
   b. Is the Certifier a Certified ECE (Elevation Certificate Expert)?

Comments:

(Comments will include any information that may help assess the risk)

Signature and Date.

An embodiment of the invention may optionally include the some or all of the following information as output variables.
1. Whether structure meets minimum criteria of the NFIP/Technical Bulliten-1 (2008, or as amended).
2. Whether structure meets aspects of risk not covered by NFIP, which concern excess flood risk (i.e., flood insurance over $250,000).
3. Output information so untrained insurance technician may identify basic questions to ask a surveying professional.
4. Output information so an untrained consumer may identify basic questions to ask an insurance company.

For example, for a garage with machinery, the output will identify whether garage is below Base Flood Elevation, and whether flood vents are too high above the bottom floor. Risk assessment output will include whether the flood vents may be moved or breakaway walls may be included, whether the machinery should be moved to reduce financial risks.

For a second example, for a crawl space, the output will identify whether additional vents are required, whether major appliances or key rooms in structure (e.g., a kitchen) are below the Base Flood Elevation. The output will include “red flags” which illustrate why the red flag exists, and how to reduce risks. The output may also identify whether NFIP minimum threshold requirements have been met, along with means of further reducing risks to the entire structure. The output may also identify whether an inspection of specific enclosed areas is warranted, and identify how to reduce risk to contents of crawl spaces and key rooms in a structure.

As additional optional output, “red flags” or other symbols may be shown on a graphical representation of the structure so insurance technicians, homeowners, and community officials with marginal expertise can understand their risk and make decisions on retrofitting to reduce that risk.

As additional optional output, adjustments to the application or program can be made for customers seeking different tolerances of risk. These “red flag” symbols may also be different for regions of the country more susceptible for flooding or for communities, or insurance companies that want to reduce risk above the NFIP minimum baseline.

In an embodiment of the invention, professional land surveyors that are measuring the data to fill out an elevation certificate can use this tool prior to submission to highlight discrepancies. A scan into a master database system can output the possible discrepancies and offer a compliance rating of that elevation certificate that will be used to gauge risk. Discrepancies can be easily altered, and mitigation tools or retrofit can be suggested that could dramatically reduce risk along with the cost of flood insurance. This service from the surveyor offers no additional risk, yet increases the value of the service substantially. This rating over time will also be used as a tool to gauge the competency of that firm.

An embodiment of the invention includes at least one pictorial representation of output for a software program analysis of at least one structure with a crawl space, garage, basement, or below-flood elevation structures, where the structure is found in a flood zone.

An additional embodiment of the invention may incorporate a sensor technology wherein the incorporated sensor technology is capable of outputting data electronically, for example to an insurer. Sensor technology may monitor conditions for detecting water or leakages; for indicating whether structures or personal property is located in an enclosed space below a base flood elevation, or similar characteristics of a real property. Among other sensor uses, sensors may be used to confirm compliance with an insurance policy, where a public or private insurer may provide conditional insurance, or for alterations to a premium for the insurance policy, based on the condition of the building indicated in the monitoring data.

In an embodiment of the invention, a public or private insurer may determine a premium alteration on the condition of the building indicated in the sensor's monitoring data in relation to information identified above, and pertaining to the grade, property, or construction of a structure.

Although the present invention has been described in detail herein with reference to the identified embodiments, it should be understood that the description is by way of example only and is not to be construed in a limiting sense. It is to be further understood, therefore, that numerous changes in the details of the embodiments of this invention and additional embodiments of this invention will be apparent to, and may be made by, persons of ordinary skill in the art having reference to this description. It is contemplated that all such changes and additional embodiments are within the spirit and true scope of this invention as claimed below. Thus, while the present invention has been described in particular reference to the general area of ophthalmic surgery, the teachings contained herein apply equally wherever it is desirous to provide insurance risk evaluation, reduced insurance premiums, identification of flood risks, identification of errors in flood plain, surveyor, or insurance risk characteristics, and related information.

1. A computer-implemented method of presenting a visual representation of flood risk analysis for a structure, the method comprising:
obtaining, by an electronics device, a set of indicators to determine structural characteristics of a real property structure;
choosing, by an electronics interface, a photographic image depicting at least one structure at a location;
modifying, by the electronics device, a photographic image to reflect flood damage risks to the at least one structure commensurate with at least one of the following methods of reducing costs of flood damage:
movement of property at the at least one structure;
use of flood vents;
use of flood vents compliant with technical requirements of National Flood Insurance Program and relevant technical bulletins;
use of breakaway walls;
displacement of machine or devices within the at least one structure;
gradient changes;
barriers;
bringing in fill to raise elevation of all or part of a structure;
evaluating historical flood plain maps to identify flood insurance requirements based on the date a structure was built; and
evaluating the lowest adjacent grade against a base flood elevation for filing letters of map amendments.

2. claim 1, where the user is one of the following: a consumer, an insurer, and an insured.

3. A data processing system having at least one processor, an accessible memory, and an accessible display, for determining the flood risk classifications of a real property, the system comprising:
an interface;
a referencing component for associating image structures and elements with elements of a structure;
a component for associating at least one real property with elevation certificate data and real property characteristics; and
a cpu for receiving and analyzing material information, and explaining in diagram and in text,
i. Whether a structure complies with base NFIP flood insurance requirements;
ii. Whether the property may qualify for insurance premiums from one or more insurers;
iii. Structural options to reduce flood risk;
iv. Financial benefits the user may review concerning financial benefits for reducing the structure's flood damage risk; and optionally,
v. Differences in insurance premiums and risks in uses of one or more risk-reducing means.

4. The system of claim 3, further comprising a method for monitoring surveyor proficiency, comprising:
obtaining data from a plurality of elevation certificates;
comparing the plurality of elevation certificates through a software application;
analyzing elevation certificates for statistically significant error rates;
providing results of the analysis on an output interface.

5. The system of claim 4, further comprising obtaining and maintaining data related to real property elevation certificate information, where the data is analyzed over time to gauge proficiency of surveyors.

6. A computer-assisted system for determining the insurance premium costs for real property, comprising:
receiving a street address of at least one property;
receiving characteristics of the at least one property;
examining the flood risk properties internal and external to the real property;
comparing elevation certificate information to a characteristics provide by an electronic interface; and
identifying flood risks.

7. The method of claim 6, further comprising identifying risks of erroneous elevation certificates, where the risk is above a predetermined threshold.

8. The method of claim 6, further comprising determining compliance with government flood insurance regulation requirements.

9. The method of claims 6, further comprising determining whether errors exist to the elevation certificate due to inconsistent parameters or elevation certificate information indicative of a risk of mistakes or a misreading by a consumer or flood plain professional.

10. A method for modeling insurance coverage, the method comprising:
providing a processor;
providing a memory coupled to a processor and including data related to at least one structure of real property;
displaying within a user interface a plurality of claim scenario parameters for flood insurance risks;
generating a claim scenario, using the processor, based on relevant claim data, values associated with structure characteristics, wherein the claim scenario identifies current flood risk premiums;
generating, using the processor and claim scenario, guidance for identifying disparities between user-input and local community-supplied information such as elevation certificate information; and
generating guidance for reducing flood insurance costs through correction of elevation certificates or changes to the at least one structure.

11. The method of claim 10, where generating a claim scenario further comprises at least one of: including pertinent flood zone classifications, including flood zone area characteristics, including elevation characteristics, including gradient characteristics, or including FEMA or national mapping information.

12. The method of claim 10, further comprising displaying data that is usable to identify flood risks for the at least one structure by highlighting at least a portion of the at least one structure on the output interface.

13. The method of claim 10, further comprising an analysis for whether the at least one structure meets criteria required by FEMA and the National Flood Insurance Program.

14. The method of claim 10, further comprising an analysis for whether the at least one structure meets criteria required by excess coverage standards for insurance companies.

15. The method of claim 10, further comprising an analysis of elevation certificates for error rates by surveyors.

16. The method of claim 10, further comprising an analysis for predicting errors for elevation certificates.

17. An apparatus for identifying flood risk, comprising:
a hand-held electronic data processing device for receiving initial information about real property, including characteristics of the real property and material elevation certificate data;
an interface providing a menu of a set of indicators to determine structural characteristics of a real property structure;
use of an application program interface to a central server to determine the cost of a range of flood insurance coverages based on the initial information;
displaying on the device a menu of flood insurance coverages and their costs;
selecting optional proposed steps for reducing flood risk by the individual using the device; and computing whether insurance cost reduction is available through:
movement of property at the at least one structure;
use of flood vents;
use of flood vents compliant with technical requirements of National Flood Insurance Program and relevant technical bulletins;
use of breakaway walls;
displacement of machine or devices within the at least one structure;
gradient change;
barriers;
bringing in fill to raise elevation of all or part of a structure;
evaluating historical flood plain maps to identify flood insurance requirements based on the date a structure was built;
evaluating the lowest adjacent grade against a base flood elevation for filing letters of map amendments.

18. A system for insuring a building structure by taking into account technologies that mitigate against loss comprising:
a database identifying a plurality of technologies that reduce risk of loss to an associated building structure; and
computer executable instructions stored in memory, for causing a processor to:
identify inconsistencies between property information and elevation certificate data; and
display benefits of uses of technologies that may reduce risks of loss due to flood events;

19. The system of claim 18, further comprising including in a building structure a sensor technology wherein the incorporated sensor technology is capable of outputting data electronically;
incorporating the sensor technology's monitoring data to indicate a condition of the building based on data output electronically by the incorporated sensor technology,
wherein the incorporated sensors include a building water detector or a building leakage detector; and further determining an alteration to a premium for the insurance policy based on the condition of the building indicated in the monitoring data.

20. The system of claim 18, wherein the premium alteration determination is further based on information stored in the database about the incorporated sensor technology that electronically output the data on which the monitoring data was based.

21. The system of claim 18, wherein the insurance policy includes an attachment point, and the premium alteration determination is further based on the attachment point.

22. The system of claim 18, wherein:
the database further identifies a plurality of building construction types;
the computer executable instructions stored in memory cause the processor to obtain data indicating a type of construction of the insured building structure, and
the determining of the premium alteration by the processor is further based on the condition of the building indicated in the monitoring data in relation to the type of construction of the building.

23. An article of manufacture comprising:
a set of application program interfaces embodied on a computer-readable medium for execution on an electronic software device in conjunction with an application program that identifies flood risk of interest to a user;
interface or interfaces receiving real property identification information and characteristics of the real property;
output interface that returns a description of recommendations for users to limit flood risks.
